(19) United States
(12) Patent Application Publication
(10) Pub. No.: US 2006/0241871 A1
(43) Pub. Date: Oct. 26, 2006

(54) Chemical analysis apparatus and method

(76) Inventor: Evgueni Kolossov, Berkshire (GB)

Correspondence Address: FULBRIGHT AND JAWORSKI LLP, 555 S. FLOWER STREET, 41ST FLOOR, LOS ANGELES, CA, 90071, US

(21) Appl. No.: 10/544,601

(22) PCT Filed: Feb. 4, 2004
(86) PCT No.: PCT/GB04/00424

§ 371 Date: May 23, 2006

(30) Foreign Application Priority Data
Feb. 4, 2003 (GB) 0302474.2

(51) Int. Cl. G06F 19/00

(52) U.S. Cl. 702/22

(57) ABSTRACT

A chemical analysis apparatus and method is disclosed. The purpose of the method is to identify subranges in data produced by a programme of chemical analysis such as QSAR or QSPR analysis. The method comprises iteratively selecting subranges of the data and calculating a regression value from a relationship between an activity of each molecule within the subrange and a structural feature of the molecule for the subrange. If this value is in excess of a predetermined threshold, then it is assumed that a linear subrange has been identified. The apparatus allows a user to adjust the subrange through interaction with a graphical display, and then re-calculate the regression value.

### BACKGROUND TO THE INVENTION

1. Field of the Invention

This invention relates to a chemical analysis apparatus and method. In particular, it relates to analysis of chemicals for drug-like activity using quantitative structure-activity relationship (QSAR) and quantitative structure-property (QSPR) methods. For the sake of convenience, in this specification use of the term “QSAR” should be interpreted as indicating both “QSAR” and “QSPR”, unless the context implicitly or explicitly suggests to the contrary. Likewise, use of the term “activity” should be interpreted as implying both “activity” and “property”.

The aim of QSAR techniques is to correlate structural or property descriptors of compounds with their activities. The descriptors are of a physical chemical nature, and include numerical parameters that quantify, amongst other possible properties, hydrophilic/hydrophobic properties, topology, electronic properties, and steric effects. The descriptors can be determined empirically by computational methods. The activities against which the descriptors are correlated may include quantifiable chemical measurements and biological assays. A principle field in which QSAR techniques are being applied is in drug design, but it has many other potential fields of activity.

The problem of subset selection in QSAR studies is one of the most important problems in developing methods for prediction activities of chemical compounds. Analyses of experimental data usually represent a set of compounds tested on the particular type of activity without taking in account the probable different mechanism of their actions. The subset selection is a process that allows a subrange to be found within the total activity range studied within which the descriptor/activity relationship is most nearly linear. Once a linearly-related subrange is identified, it can reasonably be inferred that the subrange represents a range within which the mechanism of action is similar.

A limitation of QSAR is that there has not been available a mechanism for unambiguously identifying linear subranges. Typically, this has been done manually, which means that the limits of the subranges will be essentially subjective. In practice, this often leads to the incorrect statistical models that have very low or no predictive power.

### SUMMARY OF THE INVENTION

An aim of this invention is to provide a mechanism by which subranges in a QSAR analysis can be identified with a greater degree of objectivity and accuracy than has previously been possible.

With this aim in mind, from a first aspect this invention provides a method for analysing the output results of an analysis programme by: selecting a subrange of the results; determining a regression value from a relationship between an activity of each molecule within the subrange and a structural feature of the molecule; and deciding that the subrange is a valid subrange if the regression value is below a predetermined threshold value.

The closer the regression value is to unity, the nearer the data is to being truly linear. When a linear subrange has been identified, predictions of activities within the subrange can be made with confidence.

Preferably, the regression value is determined from a plurality of criteria. This can enhance the accuracy of predication by reducing the risk that a linear relationship is erroneously identified. For example, multiple regression values may calculated, based on a range of criteria.

A method embodying the invention may further comprise a step of representing the relationship between activities of molecules and one or more properties of the molecules graphically. This can allow a user to make an initial selection of a subrange that might accord to a linear relationship.

The method may be applied iteratively. That is to say, the method may comprising adjusting the subrange, and then re-calculating the regression value. If the new regression value is higher, then the subrange is considered to be a better subrange that that which was originally selected.

There may, in fact, be several distinct mechanisms involved in the reactions over the range tested. Therefore, the method may be repeated with reference to a plurality of non-overlapping subranges to identify these mechanisms.

The eventual object is to derive a linear relationship that can be used to predict the activity of compounds within the subrange that have not been tested.

From a second aspect, this invention provides a computer program product for performing a method according to the first aspect of the invention.

Such a computer program product may include a display processor for generating a graphical display representative of the result of the analysis programme. Advantageously, the computer program product additionally allows a user to select a subrange of the results by interaction with a graphical display.

An embodiment of the invention will now be described in detail and with reference to the accompanying drawings, in which:

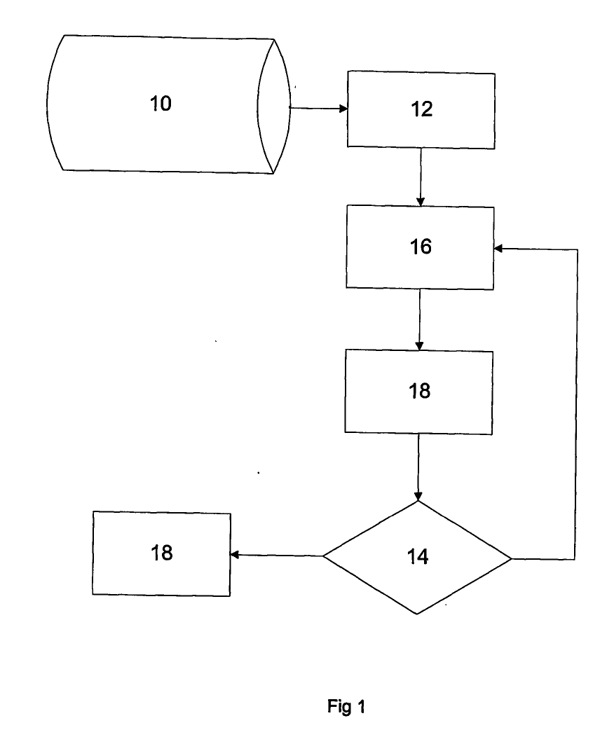

FIG. 1 is a flowchart that shows the main steps in a method embodying the invention.

The method of this embodiment starts with a conventional programme of analysis of a set of related molecules. This produces a range of analytical results that provides an activity value for each of a large number of specific molecules, the results being stored in a machine-readable file. However, that does not lead directly to the ability to predict the activity of any other molecule. It is the provision of this predictive ability that is the aim of this invention.

The invention is implemented as a computer programme product. In practice, the product will most typically be a module executable within a larger chemical analysis package. The method is performed by the software acting upon the data stored in the machine-readable file 10.

Introduction

In general, each molecule within the set of chemicals will have a structure that comprises a large number of molecule fragments, which will be designated A, B, C, . . . . In practice, for a drug-like molecule, the number of such fragments is likely to be at least in the order of 10⁴.

For any molecule within the set, it is possible to find a formula for the activity of the form:
Activity=aA+bB+cC . . . (1)
where a, b, c . . . are coefficients.

In a large analytical set, it may in fact be that a first subrange of molecules within the set obeys equation 1, while another subrange obeys the equation:
Activity=a′A+b′B+c′C . . . (2)
where
x′≠x for at least one of x=a, b, c . . . and x′=a′, b′, c′ . . .

Thus, within the entire range of molecules, the activity varies in accordance with more than one distinct linear relationships in distinct subranges. It is common to assume that each of these subranges represents distinct mechanism of action.

As stated, the purpose of QSAR analysis is to predict the activity of compounds that are not tested in the analysis programme. This can be done through equation 1 once the values of the coefficients a, b, c, . . . are calculated for molecules having values of A, B, C, . . . , but only within the subrange to which the equation with specific coefficient values holds true. Application of the equation outside of the subrange will lead to an incorrect prediction. Therefore, identification of the extent of the subranges is of critical importance.

Identification of Subranges

In this embodiment, the first step in performing the analysis is to reduce the extent of the problem by reducing the number of variables that are to be considered. This is done by a method of principal component analysis. Since this is a standard technique, and is not, in any case, essential to performing the invention, it will not be described further.

A regression value is then calculated for all of the data at step 12 and compared in step 14 with a predetermined threshold value. If the value is below the threshold, it is assumed that the entire data set behaves in accordance with a linear relationship, and the analysis need not proceed further. A regression value of 1 represents an exact fit with a linear relationship. The limits of analytical accuracy are such that a value of 1 will not normally be achieved. Therefore, the threshold value is selected as being a value that might hypothetically be achieved if the analytical techniques used in a particular QSAR programme are applied to a range of molecules that are, in fact, linearly related. The threshold value will, therefore, vary from one application of this invention to another.

Alternatively, if the regression value is above the threshold, then it is assumed that the activities of molecules within the range do not all accord to a single linear relationship. This indicates that no single linear equation can be used to predict the activities of molecules throughout the range. The inference drawn from this is that there is more than one chemical mechanism in operation within the range to produce the measured activity. Therefore, a subrange is selected step 16 and the regression value is calculated on the subrange. As before, it is assumed that there is a linear relationship if the regression value is below a predetermined threshold.

The process of selecting subranges can be repeated until as much of the full range of data as possible (or as required) is spanned by subranges that are sufficiently small to accord with a linear formula for the molecules within them. Such a subrange within which a linear relationship holds will be called a “valid subrange”.

In the event that a simple regression value indicates that the subrange is not valid, this indicates that a linear relationship does not hold. However, is the regression value is below the threshold, this may not indicate definitively that the subrange is valid because it may be that there are variables hidden from the simple regression that do not accord with the linear relationship. Therefore, in order to refine the results further, reducing the likelihood that the subrange boundary is erroneously extended or restricted, multiple regression values may be calculated.

The criteria used to calculate regression values can be multiple linear regressions at step 18 of different types, for example: multiple linear regressions between the chemical structures, descriptors and activity value, or multiple linear regressions between the number of fragments corresponding to the each chemical structure and the activity value estimated for the particular structure. Through the use of different statistical methods it is possible to expand the set of criteria. Analyses of the criteria allow measuring the quality of the selected subrange and to compare subranges. The statistical models generated for each subrange, selected on the base of analysis of multiple criteria, are particularly valuable predictive tools.

As an example of a method by which a regression might be calculated, consider an analysis that generates:
an activity vector A having a size of size of n observations;
a descriptor matrix D of the size n observations by m descriptors;
a weight coefficient vector W of the size of m descriptors; and
a misfit vector E of the size of n observations.

The activity vector is to be presented as product of multiplication of the descriptor matrix D with the weight coefficient vector W. In matrix form:
A≈D*W+E

The problem is to find W which minimises norm of E. This is performed as a “linear least squares” task and solution to it is obtained as following:
W=(D^{t}*D)⁻¹*(D^{t}*A),
where D^{t} is transposed matrix of matrix D, and matrix (D^{t}*D)⁻¹ is the inverse matrix of matrix (D^{t}*D).

The misfit vector E is obtained as following:
E=A−D*W

If (D^{t}*D) is a singular matrix then it is possible to reduce number of descriptors (for example with principal component analysis) or to create a subset of non-correlated descriptors (as in the method of Partial Least Squares (PLS)).

The prediction value is obtained as the descriptors and their weights:
Fᵢ=Dᵢ^{t}*W

The matrix (D^{t}*D)⁻¹ is also used for a standard error/variance estimation of the elements of vector W and for the confidence interval of prediction. The prediction degree of freedom DOF is the number of observations minus the number of descriptors:
DOF=n−m.
Var(Wᵢ)=(D^{t}*D)⁻¹*(E^{t}*E)/DOF
Var(Fᵢ)=(D₁*(i D^{t}*D)⁻¹*Dᵢ)*(E^{t}*E)/DOF

The Student coefficient is then used to produce a confidence interval from the standard error or variance.

Selection of Subranges

The foregoing description provides an indication of the purpose behind selection of subranges, and also shows how a valid subrange. The next task is to indicate the mechanism by which a candidate subrange can be selected prior to testing for its validity.

For any subrange, a correlation coefficient R can be calculated. If R=1, this implies that the subrange is exactly linear. A lesser value implies a departure for linearity. Given that the data are produced by an experimental programme, the value R=1 is not to be expected. Therefore, a threshold value must be selected as the value that would be expected from application of the specific experimental programme to a set of compounds that does in fact exhibit linearity. The value R can be calculated as follows:

$$R = \frac{Mean ( ( A - Mean ( A ) ) * ( F - Mean ( F ) ) )}{\sqrt{Var ( A ) * Var ( F )}}$$

$$Chi \text{-} squared \text{:} {χ}^{2} = ( {E}^{t} * E ) / DOF$$

A graph is generated that is a three-dimensional representation of the data, for example representing activity against fragments and number of molecules. This provides a user with a visualization of the distribution between the chemical compounds and biological activity value. The graphical representation can include additional data, for example fragments, clusters, and so forth. This presents to a user a visual representation of the data, which can provide an insight into the underlying chemical mechanisms that has not previously been available. This can allow a user to identify a subrange that potentially is linear.

The primary subset selection is done based on visual distribution of the points on graph. Consider a set of 1 000 compounds. After the subset selection we can have for example the next set of criteria:
Number of compounds in range=400;
Number of fragments=500;
Number of clusters=150;
Coefficient of correlation for the descriptors contribution=0.7;
Coefficient of correlation for the fragment contribution=0.75;

Now, expand the subset to include more compounds and, for example, arrive at:
Number of compounds in range=500;
Number of fragments=505;
Number of clusters=151;
Coefficient of correlation for the descriptors contribution=0.75;
Coefficient of correlation for the fragment contribution=0.85;

It is clear that only small changes, such as only 5 fragments and 1 cluster added for 100 new compounds, for slightly better values for coefficients of correlation to be obtained.
Now expand this subset further—to 700 compounds.
Number of compounds in range=700;
Number of fragments=800;
Number of clusters=250;
Coefficient of correlation for the descriptors contribution=0.45;
Coefficient of correlation for the fragment contribution =0.5;

It is clear that the final changes lead to a significantly worse result: the number of fragments and clusters is significantly less than in previous case, indicating that the coefficients of correlation are bad.

So, we will need to make an adjustment, say to 600 compounds:
Number of compounds in range=600;
Number of fragments=530;
Number of clusters=158;
Coefficient of correlation for the descriptors contribution=0.85;
Coefficient of correlation for the fragment contribution=0.88;

These example shows that the criteria can be effectively used to find the a good subset with minimal changes in the number of fragments and clusters and the best values for regression coefficients.

Together with visual subset selection, we offer the set of criterions to measure the objectives of the selection. The criteria can include be the number of compounds in subset and corresponding number of fragments, clusters, etc. for the subset.

Analysis

Finally, a formula in the general form of equation 1 is derived for each valid subrange at step 18.

1. A method for analysing the output results of an analysis programme by: selecting a subrange of the results; determining a regression value from a relationship between an activity of each molecule within the subrange and a structural feature of the molecule; and deciding that the subrange is a valid subrange if the regression value is below a predetermined threshold value.

2. A method according to claim 1 in which the regression value is determined from a plurality of criteria.

3. A method according to claim 2 in which multiple regression values are calculated.

4. A method according to any preceding claim further comprising representing the relationship between activities of molecules and one or more properties of the molecules graphically.

5. A method according to any preceding claim further comprising adjusting the subrange, and then re-calculating the regression value.

6. A method according to any preceding claim in which the method is repeated with reference to a plurality of non-overlapping subranges.

7. A method according to any preceding claim further comprising calculation of a linear equation to predict the activity of compounds within the subrange.

8. A method for analysing the output results of an analysis programme substantially as described with reference to the accompanying drawings.

9. A computer program product for performing a method according to any preceding claim.

10. A computer program product according to claim 9 including a display processor for generating a graphical display representative of the result of the analysis programme.

11. A computer program product according to claim 10 in which the computer program product additionally allows a user to select a subrange of the results by interaction with a graphical display.
